(19) United States
(12) Patent Application Publication
(10) Pub. No.: US 2005/0245120 A1
(43) Pub. Date: Nov. 3, 2005

(54) Memory card connector with hinged and latched cover

(76) Inventor: Hongjun Yin, Singapore (SG)

Correspondence Address: MOLEX INCORPORATED, 2222 WELLINGTON COURT, LISLE, IL, 60532, US

(21) Appl. No.: 11/115,569

(22) Filed: Apr. 27, 2005

(30) Foreign Application Priority Data
Apr. 29, 2004 (CN) 200420050519.2

(51) Int. Cl. H01R 13/62

(52) U.S. Cl. 439/331

(57) ABSTRACT

A memory card connector is provided for receiving a memory card having a plurality of conductive contacts. The connector includes an insulative housing mounting a plurality of conductive terminals. A cover has a receptacle for receiving the memory card. A pivot projection and socket mechanism are interengageable between the cover and the housing to mount the cover for pivotal movement between an open position to allow the memory card to be inserted into the receptacle and a closed position bringing the contacts of the memory card into engagement with the terminals on the housing and to allow the cover to slidably move from the closed position to a latched position. The pivot projection and socket mechanism includes a pivot projection on one of the cover or housing and having an elongated cross section. A round pivot socket is provided in the other of the cover or housing for receiving the pivot projection and allowing the cover to pivot between its open and closed positions. An elongated pivot prevention socket is provided adjacent the round pivot socket for receiving the elongated pivot projection when the cover slides to its latched position and preventing the cover from pivoting away from the housing.

### FIELD OF THE INVENTION

This invention generally relates to the art of electrical connectors and, particularly, to a memory card connector having a hinged cover wherein the hinge means for the cover performs a dual function of latching the cover in a closed position.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smartphones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

The memory card, itself, writes or reads via the connector and can transmit between electrical appliances, such as a word processor, personal computer, personal data assistant or the like. The card may be used in applications such as mobile or cellular telephones which are actuated and permit data access after identifying an identification code stored on a SIM (subscriber identification module) card. The SIM card has a conductive face with an array of contacts, and the mobile phone has a SIM card connector with terminals for electrical connection with the contacts of the SIM card to ensure the subscriber identification confirmation.

FIG. 1 shows a prior art memory card connector, generally designated 10, which includes an insulative base housing or terminal module 12 and an upper cover, generally designated 14, hinged or pivoted to the housing by hinge means 16. The cover may comprise a metal shell 18 and a pair of side arms 20. Housing 12 includes a plurality of terminal-receiving slots 22 which mount a plurality of conductive terminals 24. Pivot means 16 include pivot shafts within arms 20 which are inserted into pivot holes (not visible in the drawing) at the rear of housing 12. The pivot means mounts the cover to the housing for pivotal movement between an open position (as shown) to allow a memory card (not shown) to be mounted at the underside of the cover, and a closed position bringing contacts of the memory card into engagement with terminals 24. Although shown somewhat schematically, housing 12 includes a locking fastener 26 for engaging a locking clasp 28 on the cover to hold the cover in its closed position.

Although memory card connectors 10 of the prior art may be satisfactory for some purposes, the simple engagement of locking fastener 26 on housing 12 with locking clasp 28 on cover 20 often proves inadequate to hold the cover in its closed position when the connector is influenced by external factors, such as extraneous forces or impacts. Consequently, poor contacts frequently occur between the memory card and terminals 24. The present invention is directed to solving these problems by providing a memory card connector with a new and improved latch means wherein the latch means is incorporated directly into the pivot means which pivots the cover to the housing of the memory card connector.

### SUMMARY OF THE INVENTION

An object, therefore, of the invention is to provide a memory card connector with a new and improved latch means for a cover of the connector.

Another object of the invention is to provide a memory card connector with a new and improved pivot means for the cover, wherein a latch means is incorporated directly into the pivot means.

In the exemplary embodiment of the invention, a memory card connector is provided for receiving a memory card having a plurality of conductive contacts. The connector includes an insulative housing mounting a plurality of conductive terminals. A cover has a receptacle for receiving the memory card. A pivot projection and socket means are interengageable between the cover and the housing to mount the cover for pivotal movement between an open position to allow the memory card to be inserted into the receptacle means and a closed position bringing the contacts of the memory card into engagement with the terminals on the housing and to allow the cover to slidably move from the closed position to a latched position. The pivot projection and socket means include a pivot projection on one of the cover or housing and having an elongated cross section. A round pivot socket is provided in the other of the cover or housing for receiving the pivot projection and allowing the cover to pivot between its open and closed positions. An elongated pivot prevention socket is provided adjacent the round pivot socket for receiving the elongated pivot projection when the cover slides to its latched position and preventing the cover from pivoting away from the housing.

According to one aspect of the invention, the pivot projection is generally elliptical in cross-section, and the pivot socket is circular. The pivot prevention socket is generally elliptical, with an open end communicating with the circular pivot socket.

According to another aspect of the invention, a detent is provided between the pivot socket and the pivot prevention socket. The pivot projection rides or “snaps” over the detent to give an audible and/or tactile indication of the cover moving from the closed position to the latched position.

According to a further aspect of the invention, a pair of the pivot projection and socket means are provided between the cover and the housing at opposite sides of the connector. The pair of pivot projection and socket means are located between a pair of mounting portions at opposite side corners of the housing and a pair of pivot arms at opposite sides of the cover. In the preferred embodiment of the invention, the cover is stamped and formed of sheet metal material, and the pivot arms comprise a pair of spring arms to facilitate interengagement of the pivot projection and socket means.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a memory card connector according to the prior art and described in the Background, above;

FIG. 2 is a perspective view of a memory card connector according to invention, with the cover in its closed and latched position;

FIG. 3 is a fragmented perspective view of the connector, with the cover in its open position;

FIG. 4 is a perspective view of the housing and terminals of the connector, with the cover removed;

FIG. 5 is an enlarged section through the area of the novel pivot projection and socket means of the invention;

FIG. 6 is a fragmented top plan view of the connector, with the cover in its closed and latched position; and

FIG. 7 is a vertical section taken generally along line 7-7 in FIG. 6.

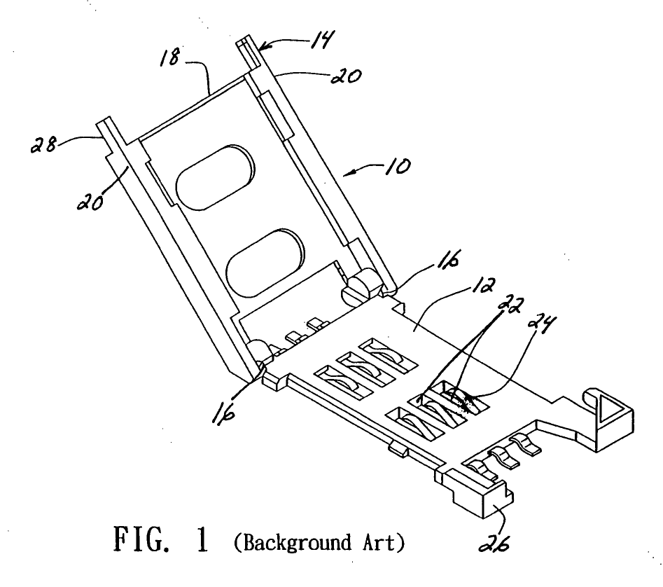

### DETAILED DESCRIPTION OF THE PREFERRED EMBODIMENT

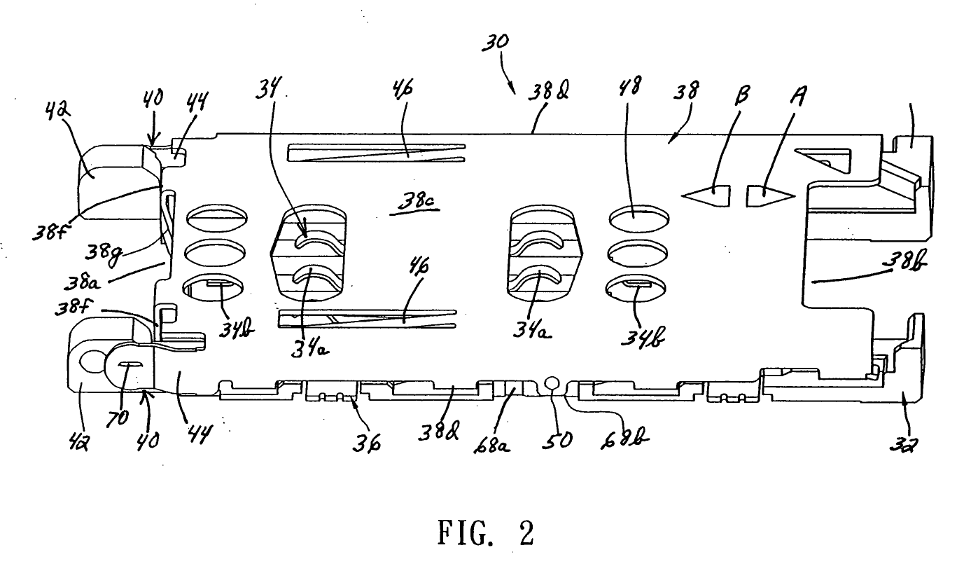

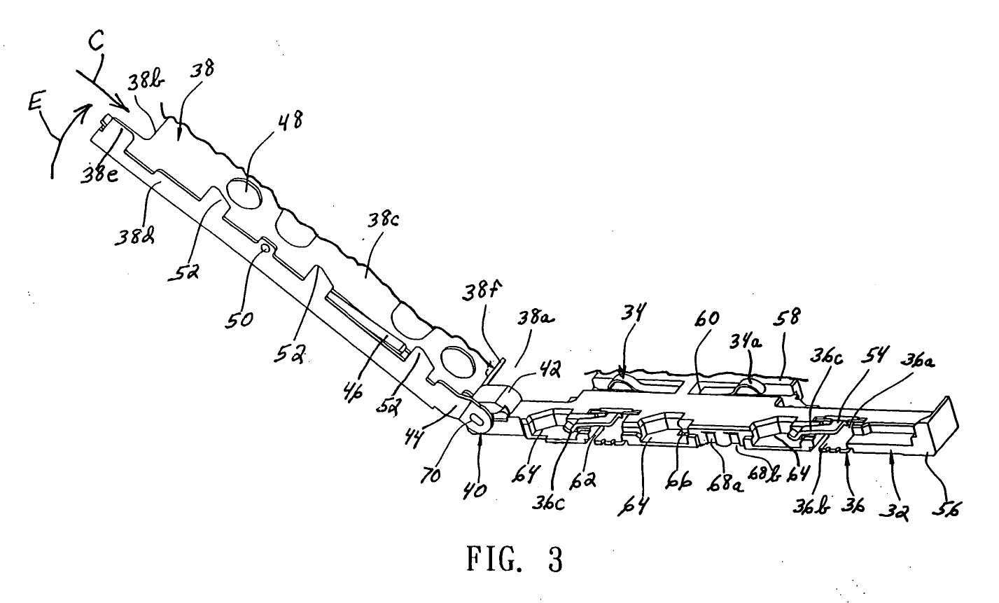

Referring to the drawings in greater detail, and first to FIGS. 2 and 3, the invention is embodied in a memory card connector, generally designated 30, for receiving a memory card (not shown) having a plurality of conductive contacts. The connector includes an insulative body or housing, generally designated 32, which mounts a plurality of signal terminals, generally designated 34, and a plurality of ground terminals, generally designated 36. A cover 38 is pivotally mounted to the housing by a pair of pivot projection and socket means, generally designated 40, at opposite sides of the connector. The cover is stamped and formed of sheet metal material.

The pivot projection and socket means 40 generally are provided between a pair of pivot blocks 42 at the rear of housing 32 and a pair of spring arms 44 at the pivot end of the stamped and formed sheet metal cover 38. Therefore, the cover is pivotally mounted to the housing for pivotal movement between an open position (FIG. 3) to allow a memory card to be mounted to the inside of the cover, and a closed position (not shown), bringing the contacts of the memory card into engagement with terminals 34 on housing 32. The pivot projection and socket means 30 then allows the cover to slidably move from its closed position to a latched position shown in FIG. 2. As will be seen hereinafter, the pivot projection and socket means performs a dual function of providing for pivotal movement of the cover between its open and closed position and sliding movement of the cover to its latched position while also latching the cover in the latched position. As seen in FIG. 2, the cover is slidably moved on the housing from its closed position to its latched position in the direction of arrow “A”. The cover is slidably moved back to its closed and pivotal position in the direction of arrow “B”.

Still referring to FIGS. 2 and 3, metal cover 38 includes a pivot end 38a and a memory card insertion end 38b. The cover includes a top wall 38c and a pair of side walls 38d. A flange 38e (FIG. 3) is bent inwardly from each side wall 38d generally parallel to top wall 38c near insertion end 38b. A pair of bottom flanges 38f are bent generally perpendicular to top wall 38c at pivot end 38a of the cover. An angled, resilient arm 38g extends from one of the bottom flanges across the pivot end of the cover. Therefore, a receptacle means is provided at the underside of cover 38 by top wall 38c, side walls 38d, flanges 38e and bottom flanges 38f. A memory card is inserted into the receptacle means of the cover in the direction of arrow “C” (FIG. 3) until an end of the memory card engages resilient arm 38g (FIG. 2). When the cover is pivoted to its closed and latched position shown in FIG. 2, a pair of spring arms 46 bias the memory card and, thereby, the contacts of the memory card into engagement with terminals 34. Spring arms 46 are stamped and formed out of top wall 38c of the cover.

Other features of the cover include a plurality of holes 48 stamped out of top wall 38c of the cover to allow for visual inspection of solder connections of terminals 34 with a printed circuit board, as will be seen hereinafter. An inwardly directed detent 50 is provided on each side wall 38d of the cover, for purposes described hereinafter. Finally, a plurality of latching flanges 52 are bent inwardly from side walls 38d, again for purposes described hereinafter.

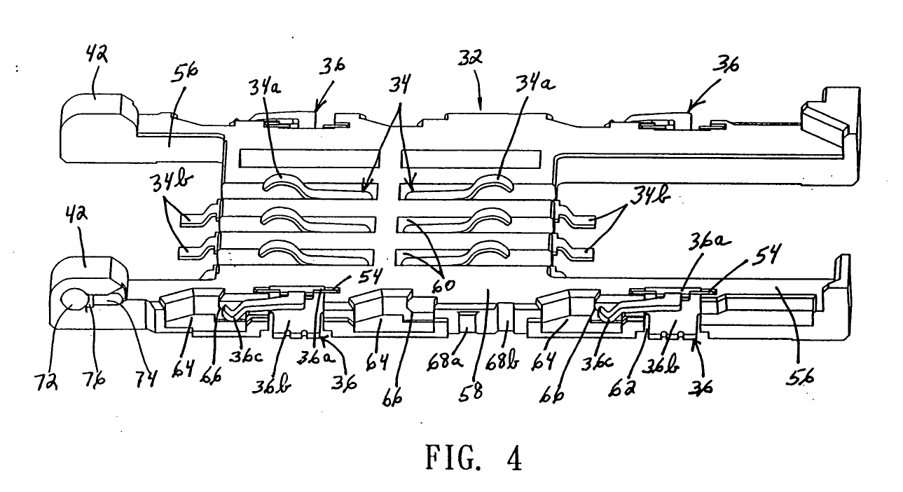

Referring to FIG. 4 in conjunction with FIGS. 2 and 3, terminals 34 include contact portions 34a and solder tail portions 34b. The contact portions are engageable with the contacts of the memory card. The solder tail portions are surface connected, as by soldering, to appropriate circuit traces on a printed circuit board. Ground terminals 36 have fixing portions 36a, solder pad portions 36b and flexible contact portions 36c. The fixing portions are inserted into mounting slots 54 in the housing to fix the ground terminals to the housing. Solder pad portions 36b are solder connected to appropriate ground traces on the printed circuit board. Contact portions 36c are engageable with latching flanges 52 of cover 38 when the cover is slidably moved in the direction of arrow “A” (FIG. 2) from its closed position to its latched position.

Still referring to FIG. 4 in conjunction with FIGS. 2 and 3, housing 32 is generally H-shaped and may be a one-piece structure molded of dielectric material such as plastic or the like. The H-shape is formed by a pair of side legs 56 and a transverse portion 58. Terminals 34 are mounted in slots 60 in the transverse portion of the housing. The housing is cut-out, as at 62, to accommodate solder pad portions 36b of ground terminals 36. Three notches 64 are formed along each opposite side of the housing for accommodating latching flanges 52 of the cover when the cover is pivoted to its closed position. A latching shoulder 66 is formed at a front end of each notch. It can be seen best in FIG. 4 that the contact portion 36c of each ground terminal 36 generally is in alignment with one of the latching shoulders 66. Finally, a pair of detent grooves 68a and 68b are formed in each side of housing 32 for interengagement with detents 50 of the cover for purposes described hereinafter.

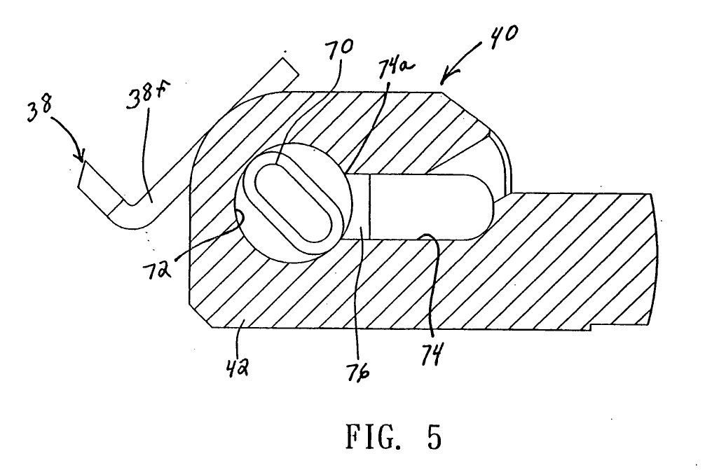

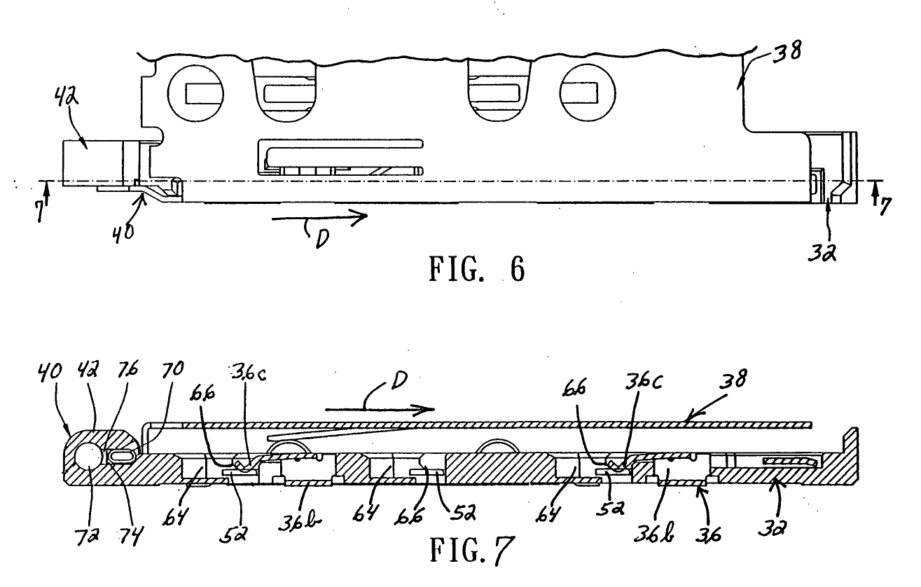

Referring to FIG. 5 in conjunction with FIGS. 2-4, one of the pivot projection and socket means 40 at opposite sides of the connector is shown in FIG. 5 in greater detail. Specifically, a pivot projection 70 is formed in each spring arm 44 of cover 38 to project inwardly toward the respective pivot block 42 of the housing. The pivot projection is elongated, such as being generally elliptical in cross-section. The pivot projection is positioned within a socket array formed in the outside surface of the respective pivot block 42 as best seen in FIG. 4. The socket array includes a round or circular pivot socket 72 and a forwardly extending, elongated pivot prevention socket 74 which is adjacent to the pivot socket and has an open end 74a communicating with the pivot socket. A raised “bump” or detent 76 is formed between sockets 72 and 74. FIG. 5 shows pivot projection 70 in an orientation corresponding to the open position of cover 38 as shown in FIG. 3. FIGS. 6 and 7 show the cover pivoted to its closed position and slidably moved in the direction of arrows “D” to its latched position. It can be seen in FIG. 7 that the elongated or elliptically shaped pivot projection 70 has moved into the elongated or elliptically shaped pivot prevention socket 74 in a fairly snug condition. Therefore, cover 38 is prevented from pivoting upwardly or away from housing 32 because of the interengagement of the long sides of the elongated pivot projection with the long sides of socket 74.

In operation of connector 30, a memory card is inserted into cover 38 in the direction of arrow “C” with the cover in its open position as shown in FIG. 3. As stated above, the pivot projection and socket means 40 are in the condition shown in FIG. 5 when the cover is open.

Cover 38 then is pivoted in the direction of arrow “E” (FIG. 3) to its closed position on top of housing 32. During this pivoting movement, pivot projection 70 simply rotates within circular pivot socket 72. Latching flanges 52 on the cover drop into notches 64 in the housing.

After the cover is pivoted to its closed position, the cover then is slidably moved relative to housing 38 in the direction of arrows “D” (FIGS. 6 and 7), to move the cover from its closed position to a latched position as shown in FIGS. 6 and 7. During this movement a number of things happen. First, pivot projection 70 moves from pivot socket 72 into the pivot prevention socket 74. During this movement, the pivot projection snaps over detent 76 between the two sockets to create a “snapping” action and render an audible and/or tactile indication of the cover moving from its closed position to its latched position. An additional clicking indication is given as detents 50 on the cover “snap” from detent grooves 68a to detent grooves 68b at the sides of the housing. Detents 76 and 50 combine to prevent unintentional sliding movement of the cover back from its latched position to its closed/pivotal position. Of course, the detents can be overcome by manually pushing the cover back in the direction of arrow “B” in FIG. 2.

Finally, when cover 38 is slidably moved relative to the housing from its closed position to its latched position shown in FIGS. 6 and 7, latching flanges 52 slide under latching shoulders 66 within recesses 64 of the housing. This positively locks the cover to the housing and prevents the cover from being lifted even by excessive forces. Flanges 52 also slide into engagement with contact portions 36 of ground terminals 36 to ground the cover to the printed circuit board.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A memory card connector for receiving a memory card having a plurality of conductive contacts, comprising:
an insulative housing mounting a plurality of conductive terminals;
a cover having receptacle means for receiving the memory card; and
pivot projection and socket means interengageable between the cover and the housing to mount the cover for pivotal movement between an open position to allow the memory card to be inserted into the receptacle means and a closed position bringing the contacts of the memory card into engagement with the terminals on the housing and to allow the cover to slidably move from the closed position to a latched position, said pivot projection and socket means including
a pivot projection on one of the cover or housing and having an elongated cross section,
a round pivot socket in the other of the cover or housing for receiving the pivot projection and allowing the cover to pivot between said open and closed position, and
an elongated pivot prevention socket adjacent the round pivot socket for receiving the elongated pivot projection when the cover slides to said latched position and preventing the cover from pivoting away from the housing.

2. The memory card connector of claim 1 wherein said pivot projection is generally elliptical in cross-section and said round pivot socket is circular.

3. The memory card connector of claim 2 wherein said pivot prevention socket is generally elliptical with an open end communicating with the circular pivot socket.

4. The memory card connector of claim 1, including a detent between the pivot socket and the pivot prevention socket over which the pivot projection “snaps” to give an audible and/or tactile indication of the cover moving from the closed position to the latched position.

5. The memory card connector of claim 1, including a pair of said pivot projection and socket means between the cover and the housing at opposite sides of the connector.

6. The memory card connector of claim 5 wherein said pair of pivot projection and socket means are located between a pair of mounting portions at opposite side corners of the housing and a pair of pivot arms at opposite sides of the cover.

7. The memory card connector of claim 6 wherein said cover is stamped and formed of sheet metal material and said pivot arms comprise a pair of spring arms to facilitate interengagement of the pivot projection and socket means.

8. A memory card connector for receiving a memory card having a plurality of conductive contacts, comprising:
an insulative housing mounting a plurality of conductive terminals;
a cover having receptacle means for receiving the memory card; and
a pair of pivot projection and socket means interengageable between the cover and the housing at opposite sides of the connector to mount the cover for pivotal movement between an open position to allow the memory card to be inserted into the receptacle means and a closed position bringing the contacts of the memory card into engagement with the terminals on the housing and to allow the cover to slidably move from the closed position to a latched position, said pivot projection and socket means including;
a pivot projection on one of the cover or housing and having an elliptical cross section,
a circular pivot socket in the other of the cover or housing for receiving the pivot projection and allowing the cover to pivot between said open and closed position, and
an elliptical pivot prevention socket having an open end communicating with the round pivot socket for receiving the elliptical pivot projection when the cover slides to said latched position and preventing the cover from pivoting away from the housing.

9. The memory card connector of claim 8 wherein each pivot projection and socket means include a detent between the pivot socket and the pivot prevention socket over which the pivot projection “snaps” to give an audible and/or tactile indication of the cover moving from the closed position to the latched position.

10. The memory card connector of claim 8 wherein said pair of pivot projection and socket means are located between a pair of mounting portions at opposite side corners of the housing and a pair of pivot arms at opposite sides of the cover.

11. The memory card connector of claim 10 wherein said cover is stamped and formed of sheet metal material and said pivot arms comprise a pair of spring arms to facilitate interengagement of the pivot projection and socket means.

12. A memory card connector for receiving a memory card having a plurality of conductive contacts, comprising:
an insulative housing mounting a plurality of conductive terminals;
a cover having receptacle means for receiving the memory card; and
pivot means interengageable between the cover and the housing to mount the cover for pivotal movement between an open position to allow the memory card to be inserted into the receptacle means and a closed position bringing the contacts of the memory card into engagement with the terminals on the housing and to allow the cover to slidably move from the closed position to a latched position, said pivot means including latch means for preventing the cover from pivoting back to its open position whereby the singular pivot means performs a dual function of pivoting the cover to the housing for pivotal movement between the open position and the closed position and also preventing the cover from pivoting from its latched position.

13. The memory card connector of claim 12 wherein said pivot means include a pivot projection on one of the cover or housing insertable into a socket array in the other of the cover or housing.

14. The memory card connector of claim 13 wherein said socket array includes a pivot socket for receiving the pivot projection and allowing the cover to pivot between said open and closed positions and a pivot prevention socket for preventing the cover from pivoting away from its latched position.
